(19) United States
(12) Patent Application Publication
(10) Pub. No.: US 2006/0117226 A1
(43) Pub. Date: Jun. 1, 2006

(54) Data communication system and data communication method

(75) Inventor: Tetsuya Hirano, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/289,711

(22) Filed: Nov. 30, 2005

(30) Foreign Application Priority Data
Dec. 1, 2004 (JP) P2004-348622

(51) Int. Cl. G06F 11/00; G06F 13/00

(52) U.S. Cl. 714/43; 710/110

(57) ABSTRACT

A data communication system is able to reliably identify a cause of a transfer error even when transfer errors occur in a plurality of bus masters. The data communication system includes a bus to which a plurality of bus masters and a plurality of bus slaves are connected and which transfers a data between a bus master and a bus slave; a data storage unit having a plurality of data storage regions corresponding to the plurality of bus masters; a detection unit for detecting the transfer error; and a control unit for identifying a bus master and a bus slave involved in the transfer error and transfer-related data including at least an address on the bus slave from the data on the bus in accordance with the transfer error detected by the detection unit and storing the data identifying the bus slave and the transfer-related data in a data storage region corresponding to the identified bus master.

### CROSS REFERENCES TO RELATED APPLICATIONS

The present invention contains subject matter related to Japanese Patent Application No. 2004-348622 filed in the Japan Patent Office on Dec. 1, 2004, the entire contents of which being incorporated herein by reference.

### BACKGROUND OF THE INVENTION

1. Field of Invention The present invention relates to a data communication system and a data communication method, using a bus for transferring data between a master and slave.

2. Description of the Related Art

A data communication system providing a common data bus for data communication required among a plurality of data communication apparatuses, connecting a plurality of data communication apparatuses to the bus, and performing data communication among the data communication apparatuses via the bus is widely utilized.

In such a data communication system, since one common data bus is used for data communication of a plurality of data communication apparatuses, there is the advantage that there is no need to increase connection lines between data communication apparatuses even in a large scale data communication system having a large number of data communication apparatuses. On the other hand, a plurality of data communication operations cannot be simultaneously carried out on the common data bus. For this reason, when a plurality of data communication operations simultaneously occur, the data communication operations are sequentially executed in an order determined based on a predetermined priority order.

Usually, when a bus is used for data communication, the data communication operation is carried out between the apparatus accessing the bus to transmitting bus signals e.g. address, control signal, write data etc. to the bus (hereinafter referred to as a “bus master”) and the apparatus acquiring the bus signal to execute processing based on content indicated by the bus signal (hereinafter referred to as a “bus slave”). As a routine for that, first the data communication processing content requested by the bus master is transmitted as a bus signal to the bus, then, when the bus slave acquires that bus signal, the processing indicated by the bus signal is executed and, according to the content of the instructions from the bus master, the execution result is returned to the bus master via the bus.

Such a data communication system is configured so that for example when the bus master sends the above bus signal through the bus to a bus slave using an address which does not exist as the bus slave, an address decoder connected to the bus returns a transfer error signal to the bus master at an accessing side. At this time, when at the bus master the accessing side has a circuit having a processing function, for example a CPU of a microprocessor, the CPU holds the address at which the transfer error occurs in an internal register and performs for example a non-maskable interrupt (NMI), therefore can identify the cause of transfer error. The NMI will be explained in the embodiments of the present invention.

However, when a transfer error occurs due to designation of an erroneous address by the bus master not having a CPU or other processing function, the bus master cannot identify the cause of such transfer error. As an example of the bus master not having a CPU or other processing function, for example there is a direct memory access controller (DMAC). The DMAC can store the information that a transfer error occurred, but cannot perform processing for judging the transfer error. Therefore, the DMAC must interrupt the CPU of the information processing master computer located at a higher level than the DMAC, make the CPU of the information processing master computer read the transfer error, and make the CPU of the information processing master computer perform the processing for judging the transfer error etc. In this way, the DMAC itself cannot analyze the cause of the transfer error (performing debugging). Alternatively, when the bus slave is a memory, sometimes it is attempted to transfer data exceeding its memory capacity from the bus master to the bus slave or sometimes the data is transferred to a not-existing memory address.

In an “on chip bus” system referred to as SoC (System on Chip) mounting a CPU and its related circuits as a core part and connecting various types of blocks on a semiconductor chip, the number of bus masters increases. Sometimes a plurality of bus masters substantially simultaneously perform data communication operations, so the data communication control becomes complex. Further, if a transfer error occurs, it is difficult to analyze the reason (cause) of the transfer error. In addition, in a data communication system in which such multiple masters operate, the transfer error by a certain bus master sometimes induces a transfer error of the other bus masters. When such complex transfer errors occur, it is very difficult to analyze the cause of the transfer error.

### SUMMARY OF THE INVENTION

It is therefore desirable is to provide a data communication system and method able to identify the reasons (causes) of a transfer error even in the case where the transfer error occurs in a plurality of bus masters.

According to a first aspect of the present invention, there is provided a data communication system including a bus to which a plurality of bus masters and a plurality of bus slaves are connected and which transfers a data between a bus master and a bus slave; a data storage unit having a plurality of data storage regions corresponding to the plurality of bus masters; a detection unit for detecting a transfer error; and a control unit for identifying a bus master, a bus slave and a transfer-related data from the data on the bus in accordance with the detection of the transfer error by the detection unit, the bus master and the bus slave which are related to the transfer error, and the transfer-related data which includes at least an address on the bus slave, and storing the data identifying the bus slave and the transfer-related data, in a data storage region corresponding to the identified bus master.

Preferably, the detection unit detects the transfer error, one bus master among the plurality of bus masters accesses the data storage unit.

Preferably, the system further includes an arbitration unit for arbitrating a data transfer requests of the plurality of bus masters, giving a data transfer grant to one bus master, and transmitting a first data identifying the one bus master to the bus, the bus master given the data transfer grant transmits a second data identifying the bus slave and third data identifying the address on the bus slave to the bus; and the bus slave identified by the bus master transmits fourth data indicating whether or not the data is properly transferred to the bus.

Preferably, the detection unit detects the transfer error based on the fourth data, and the control unit identifies the bus master based on the first data, in accordance with the transfer error detected by the detection unit, and stores the second and third data in the data storage region corresponding to the bus master.

According to a second aspect of the present invention, there is provided a data communication method for transferring a data on a bus to which a plurality of bus masters and a plurality of bus slaves are connected, including: a step of detecting a transfer error; a step of identifying a bus master, a bus slave and a transfer-related data from the data on the bus, the bus master and the bus slave which are related to the transfer error, the transfer-related data which includes at least an address on the bus slave; a step of storing the data of the bus slave and the transfer-related data in a data storage region corresponding to the identified bus master; and a step of accessing the data storage region by one bus master among the plurality of bus masters.

In the present invention, the detection unit detects the bus master and the bus slave involved in the transfer error and the transfer-related data including at least the address on the bus slave from the data on the bus and stores the data of the bus slave and the transfer-related data in the data storage region corresponding to the identified bus master.

Therefore, according to the present invention, irrespective of the bus master, contents of transfer errors involved in transfer of all bus masters are independently stored in the corresponding data storage regions. Therefore, no matter which of a plurality of bus masters a transfer error occurs at, the cause of the transfer error can be reliably identified. Accordingly, a system having a high reliability can be achieved.

### BRIEF DESCRIPTION OF THE DRAWINGS

These and other objects and features of the present invention will become clearer from the following description of the preferred embodiments given with reference to the attached drawings, wherein:

FIG. 1 is a diagram showing the configuration of a bus system according to an embodiment of the present invention;

FIG. 2 is a diagram illustrating various signals input/output to/from an arbiter shown in FIG. 1;

FIG. 3 is a diagram illustrating various signals input/output to/from bus masters shown in FIG. 1;

FIG. 4 is a diagram illustrating various signals input/output to/from bus slaves shown in FIG. 1;

FIG. 5 is a block diagram showing the configuration of an error monitor unit shown in FIG. 1; and

FIG. 6 is a diagram illustrating the configuration of an error register group in the error monitor unit illustrated in FIG. 5.

### DESCRIPTION OF THE PREFERRED EMBODIMENTS

Below, an embodiment of the data communication system according to the present invention will be explained with reference to the attached drawings.

Note that, in the following explanation, with respect to any signal A comprised of a plurality of bits, for example a signal A [1:0] indicates that 2 bits in total from a higher first bit to a lower 0-th bit are data. Further, for example, A[1:0]=“01” indicates that a higher first bit of A[1:0] is “0” which is a low level on a bus, and a lower 0-th bit of A[1:0] is “1” which is a high level on the bus.

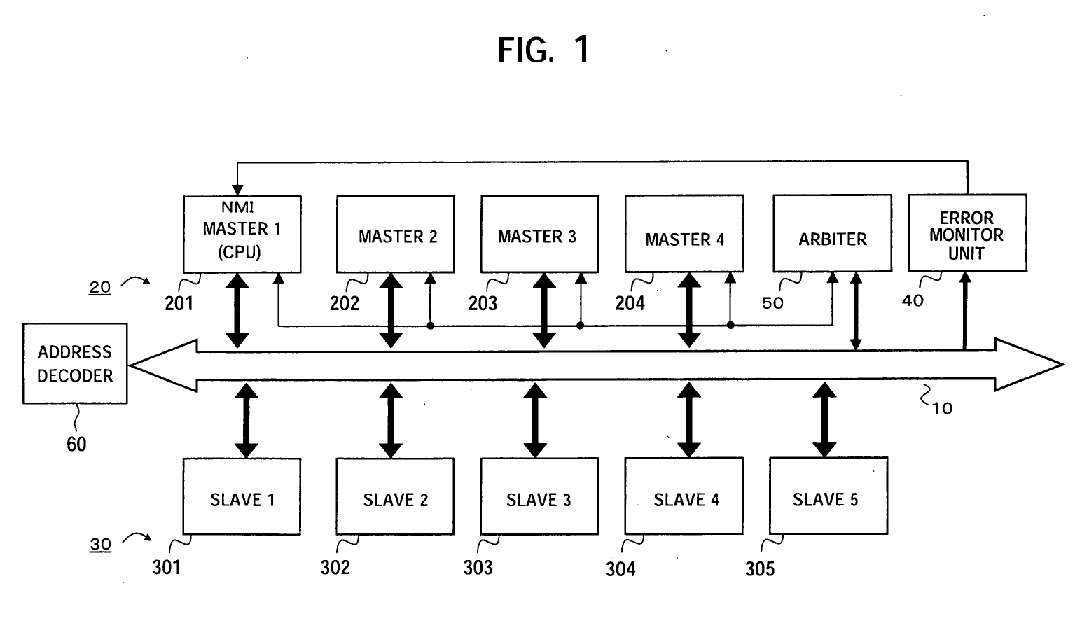

FIG. 1 is a diagram showing the configuration of a data communication bus system 1 using a common bus for data communication when performing the data communication between a plurality of bus masters and a plurality of bus slaves according to an embodiment of the present invention. The data communication bus system 1 according to the present embodiment has a common bus 10, a bus master group 20 comprising a plurality of bus masters 201 to 204, a bus slave group 30 comprising a plurality of bus slaves 301 to 305, an error monitor unit 40 for monitoring for transfer error, an arbiter 50 as an arbitrating means of the present invention, for arbitrating the priority order of the bus communications, address data 60, and a control line 70 connecting the bus masters 201 to 204 and the arbiter 50.

Note that a master designation signal HMASTER [3:0], a selection signal HSELn, and an address signal HADDR [31:0] are examples of the first data, the second data, and the third data of the present invention. A transfer response signal HRESP [1:0] is an example of the fourth data of the present invention. A transfer direction signal HWRITE of 1 bit is an example of the fifth data of the present invention. A transfer size signal HSIZE [2:0] is an example of the sixth data of the present invention. A burst transfer signal HBURST [2:0] is an example of the seventh data of the present invention.

As an embodiment in the data communication bus system 1 according to the present embodiment, the bus master is for example a CPU, DMAC, or digital signal processor (DSP), and the bus slave is for example a peripheral device of the CPU such as a memory, display device, or printer. Naturally, the working of the present invention is not limited to such devices.

In the data communication bus system 1 according to the present embodiment, in the bus master group 20, the first bus master 201 is the CPU itself or has a CPU, has an NMI (non-maskable interrupt) function, and has an NMI terminal. The interruption by the NMI is a forcible interruption which cannot be masked by a program operating in the CPU. The first bus master 201 performs usual data communication and, in addition, is interrupted by an NMI command signal given from the error monitor unit 40 to the NMI terminal, and performs processing concerning the transfer error. The data communication bus system 1 of the present embodiment has at least one bus master for performing the NMI processing.

The error monitor unit 40 monitors the signal on the bus 10 output from the bus masters and decides whether or not any transfer error exists. When detecting a transfer error, it stores the information concerning the transfer error, for example, the transfer error content, occurrence time, etc., for each bus master causing the transfer error. Further, the error monitor unit 40 gives the NMI command signal to the NMI terminal of the first bus master 201. Details of the operation of the error monitor unit 40 will be explained in detail later.

The bus 10 in this embodiment is for example a bus based on an AMBA (Advanced Microcontroller Bus Architecture) specification of ARM Corp. The AMBA standard is an on chip bus standard being de facto established in the fields of for example controllers of storage of hard disks etc., networks, various peripheral devices, and mobile phones.

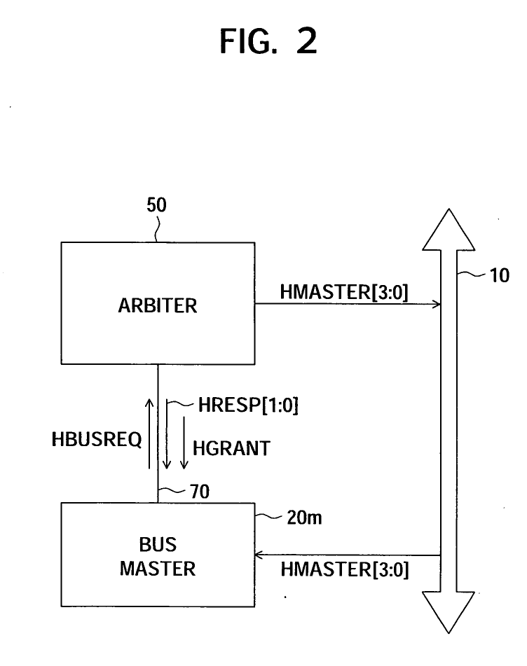

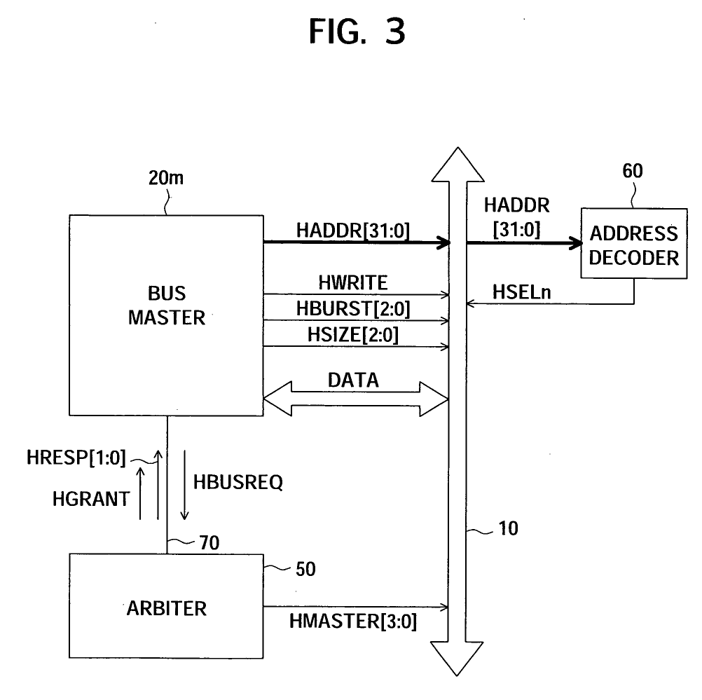

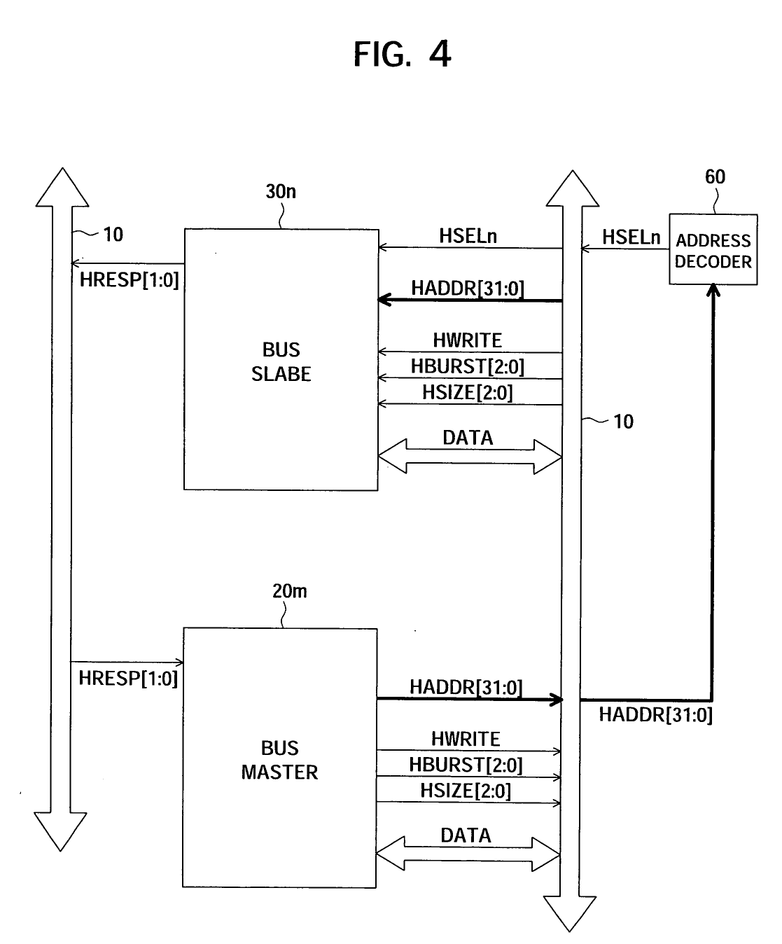

The transfer operation by the bus 10 will be explained next with reference to FIG. 2 to FIG. 4. FIG. 2 is a diagram illustrating various signals input/output to/from the arbiter 50 connected to a bus 10 and each bus master 20m (“each bus master 20m” means any bus master among the bus masters 201 to 204 exemplified in FIG. 1 or all of bus masters 201 to 204) via the control line 70. FIG. 3 is a diagram illustrating various signals input/output to/from the arbiter 50 connected via the control line 70 and each bus master 20m connected with the bus 10. FIG. 4 is a diagram illustrating various signals input/output to/from each bus slave 30n connected to the bus 10 (“each bus slave 30n” means any bus slave among the bus slaves 301 to 305 exemplified in FIG. 1 or all of bus slaves 301 to 305). Note that each bus master 20m and each bus slave 30n receive as an input clock signal for setting timing of the bus transfer and reset signals for resetting the status of the bus 10, but the clock signal is omitted in FIGS. 2 to 4.

As shown in FIG. 2 and FIG. 3, a transfer request signal HBUSREQ and a transfer grant signal HGRANT are transferred between each bus master 20m and the arbiter 50 via the control line 70.

Each bus master 20m requests an access right for transferring data to the bus 10 from the arbiter 50 by the transfer request signal HBUSREQ. The arbiter 50 acquires the transfer request signal HBUSREQ from each bus master 20m at a predetermined timing. When a plurality of data transfer requests simultaneously occur, it determines the priority order of the plurality of bus masters 20m accessing the bus 10 based on a predetermined arbitration algorithm and gives to the corresponding bus master 20m as a result a transfer grant signal HGRANT indicating transfer grant giving it the access right for data transfer. Simultaneously with that, the arbiter 50 changes the information related to the transfer grant, that is, the 4-bit master designation signal HMASTER [3:0] identifying the bus master, as so as to identify the bus master given the transfer grant and transmits it to the bus 10. The master designation signal HMASTER [3:0] is a signal including information indicating that the data transfer is granted to the bus master having the highest priority order at that point of time.

When the transfer is granted by the arbiter 50, the bus master 20m granted the transfer transmits an address signal and various control signals to the bus 10 and starts the transfer.

The data transfer processing using the bus 10 has two phases: an address phase (address information transfer stage) for transferring the 32-bit address signal HADDR [31:0] and a data phase (data transfer stage) of transferring the data for transfer (write) from the bus master 20m to the bus slave 30n or the data for transfer (read) from the bus slave 30n to each bus master 20m following that. The address signal HADDR [31:0] transmitted from the bus master 20m to the bus 10 is input to the address data 60, whereby the selection signal HSELn (n=1 to 5 in the present embodiment) for selecting the bus slave involved in the transfer is generated in the address data 60. For example, the selection signal HSEL2 of n=2 is the signal for selecting the bus slave 302. As shown in FIG. 4, the selected bus slave acquires the address signal HADDR [31:0], the selection signal HSELn, and three types of control signals, that is, a 1-bit transfer direction signal HWRITE indicating the transfer direction, a 3-bit transfer size signal HSIZE [2:0] indicating the transfer size, and a 3-bit burst transfer signal HBURST [2:0].

The bus master 20m transmits the above three types of control signals to the bus 10 at the same timing as the timing for transmitting the address signal HADDR [31:0] to the bus 10 in the address phase. The above three types of control signals correspond to the transfer-related data of the present invention. A specific example of the three types of control signals will be explained next.

Specifically, the transfer direction signal HWRITE is defined as follows.

Transfer direction signal HWRITE

(i) Case of HWRITE=“1”: Data transfer from a bus master to a bus slave, that is, write transfer (write)

(ii) Case of HWRITE=“0”: Data transfer from a bus slave to a bus master, that is, read transfer (read)

Transfer Size Signal HSIZE [2:0]

The present example shows an example of transfer of data of a multiple of 8 bits of from 8 to 1024.

(i) Case of HSIZE [2:0]=Case of “000”: Transfer size=8 bits

(ii) Case of HSIZE [2:0]=Case of “001”: Transfer size=16 bits

(iii) Case of HSIZE [2:0]=Case of “010”: Transfer size=32 bits

(iv) Case of HSIZE [2:0]=Case of “011”: Transfer size=64 bits

(v) Case of HSIZE [2:0]=Case of “100”: Transfer size=128 bits

(vi) Case of HSIZE [2:0]=Case of “101”: Transfer size=256 bits

(vii) Case of HSIZE [2:0]=Case of “110”: Transfer size=512 bits

(viii) Case of HSIZE [2:0]=Case of “111”: Transfer size=1024 bits

Burst Transfer Signal HBURST [2:0]

The bus 10 in the data communication bus system 1 in the present embodiment performs burst transfer. The burst operation in the data transfer becomes as follows according to the burst transfer signal transmitted from the bus master,

HBURST [2:0].

(i) Case of HBURST [2:0]=Case of “000”: Single transfer (SINGLE)

(ii) Case of HBURST [2:0]=Case of “001”: Increment type burst transfer of indefinite length (INCR)

(iii) Case of HBURST [2:0]=Case of “010”: 4-bit wrap type burst transfer (WRAP4)

(iv) Case of HBURST [2:0]=Case of “011”: 4-bit increment type burst transfer (INCR4)

(v) Case of HBURST [2:0]=Case of “100”: 8-bit wrap type burst transfer (WRAP8)

(vi) Case of HBURST [2:0]=Case of “101”: 8-bit increment type burst transfer (INCR8)

(vii) Case of HBURST [2:0]=Case of “110”: 16-bit wrap type burst transfer (WRAP16)

(viii) Case of HBURST [2:0]=Case of “111”: 16-bit increment type burst transfer (INCR16)

After the bus master 20m obtaining the access right of the data transfer starts the transfer, the bus slave receiving the transfer information via the bus 10 transmits a 2-bit transfer response signal HRESP [1:0] to the bus 10 as shown in FIG. 4 as the response indicating the status of the transfer. The bus master 20m acquires this transfer response signal at the predetermined timing.

The transfer response signal HRESP [1:0] is as follows.

Transfer response signal HRESP [1:0]

(i) Case of HRESP [1:0]=“00”: Indicates that the transfer state is normal and that the transfer is normally advancing.

(ii) Case of HRESP [1:0]=“01”: Indicates that the transfer state is error and that the transfer has failed.

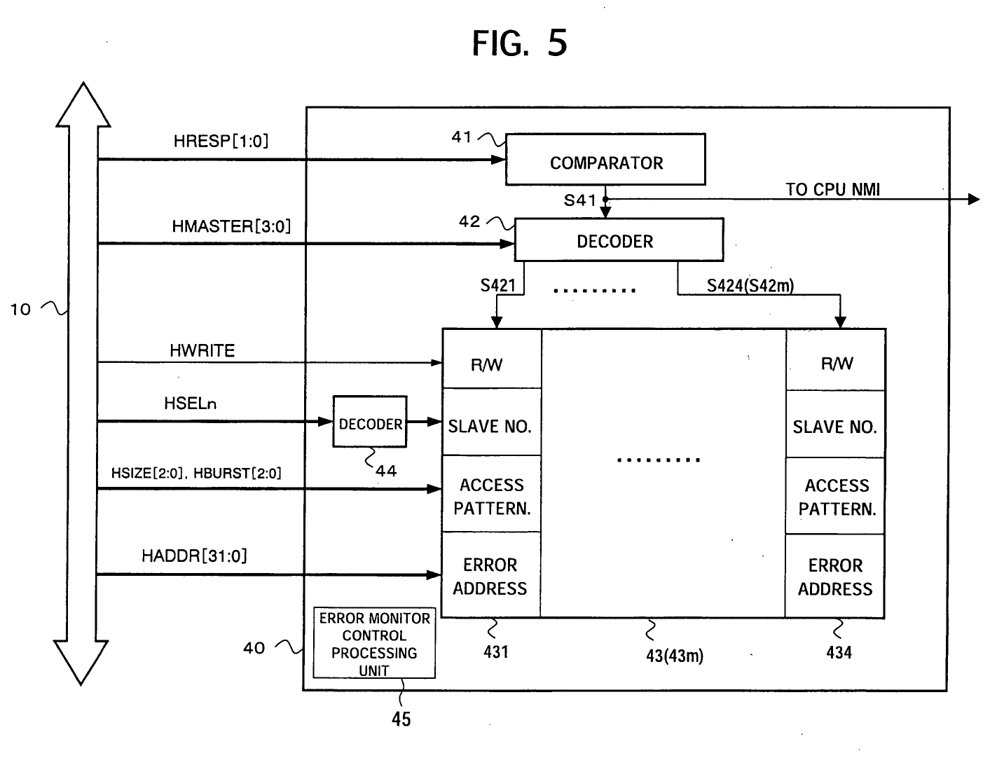

FIG. 5 is a block diagram showing the configuration of the error monitor unit 40. The configuration of the error monitor unit 40 and the operation content thereof will be explained related to FIG. 5.

The error monitor unit 40 has a first comparator 41, first and second decoders 42 and 44, an error register group 43, and an error monitor control processing unit 45. The first comparator 41, the first and second decoders 42 and 44, and the error register group 43 perform the following operation under the control of the error monitor control processing unit 45. Preferably, the error monitor control processing unit 45 includes a CPU having a processing function.

The error register group 43 is configured by a plurality of error registers 43m (in the present embodiment, m=1 to 4) corresponding to the plurality of bus masters 20m in the bus master group 20. Namely, the error registers corresponding to the bus masters 20m (m=1 to 4) become the error registers 43m (m=1 to 4).

The error monitor unit 40, particularly the error monitor control processing unit 45, corresponds to the control unit of the present invention. The first comparator 41 is an embodiment of the detection unit of the present invention. The error register group 43 is an embodiment of the data storage unit of the present invention.

The first comparator 41 receives as input the transfer response signal HRESP [1:0] on the bus 10, decides whether or not the transfer response signal HRESP [1:0] coincides with the granted standard transfer request signal, and judges whether or not the transfer state is error. The first comparator 41 decides that the transfer state is error and changes the error signal S41 from a low level to high level when the transfer response signal HRESP [1:0] coincides with “01”. The error signal S41 is given to the NMI terminal of the first bus master 201. By this, the first bus master 20 performs forcible interruption processing for accessing the error register group 43 in cooperation with the error monitor control processing unit 45 of the error monitor unit 40.

The first decoder 42 decodes the error signal S41 and the master designation signal HMASTER [3:0] on the bus 10 and generates a latch signal S42m for latching the corresponding error register 43m in the error register group 43. Namely, the first decoder 42 decodes the master designation signal HMASTER [3:0] and generates a signal identifying which bus master 20m uses the bus 10. Then, the first decoder 42 outputs the latch signal S42m having a logic “1” or “0” by taking a logical AND (AND) of this generated signal and the error signal S41. For example, when the generated signal and the error signal S41 coincide, that is, when the bus master generating the error is identified, the logic of the latch signal S42m becomes “1”.

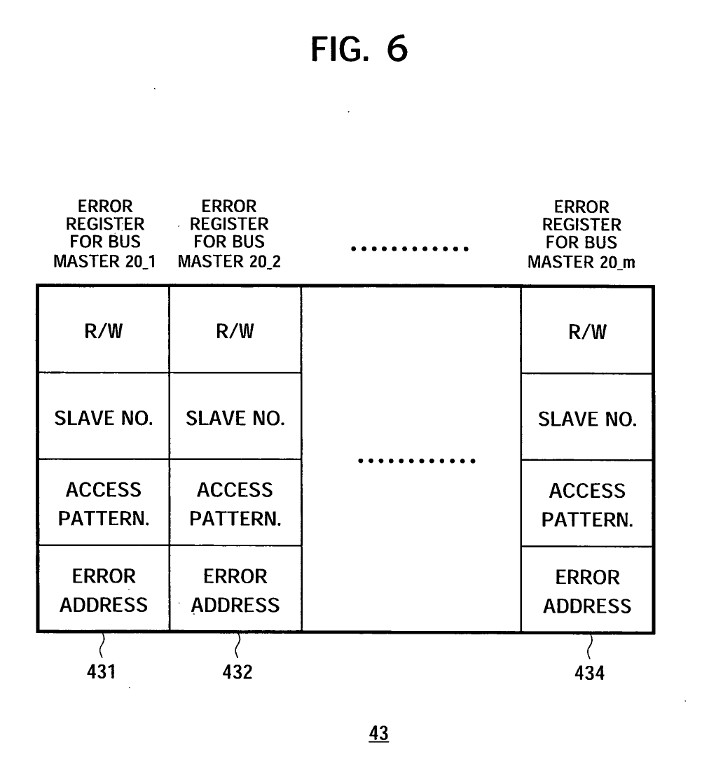

FIG. 6 is a diagram illustrating the configuration of the error register group 43. Each error register 43m of the error register group 43 includes the following storage regions for each corresponding bus master 20m.

(1) Read/write designation storage region (R/W)

(2) Slave No. storage region (Slave No.)

(3) Access pattern storage region (Access Pattern)

(4) Address storage region (Error Address)

When an error register 43m is latched by the latch signal S42m having the logic=“1”, at the latched timing, the error monitor control processing unit 45 of the error monitor unit 40 fetches the address signal, control signal, etc. on the bus 10 and stores the same in the corresponding error register 43m. Concretely, it performs the operation as follows.

The error monitor control processing unit 45 of the error monitor unit 40 fetches the transfer direction signal HWRITE (“1”: write, “0”: read) on the bus 10 and stores it in the read/write designation (R/W) storage region in the error register 43m.

The error monitor control processing unit 45 of the error monitor unit 40 decodes the selection signal HSELn on the bus 10 by the second decoder 44. The error register 43m stores the bus slave number identified by the decoding in the slave number storage region (Slave No.) under the control of the error monitor control processing unit 45.

The error monitor control processing unit 45 of the error monitor unit 40 fetches the transfer size signal HSIZE [2:0] and the burst transfer signal HBURST [2:0] on the bus 10 and stores the same in the access pattern storage region (Access Pattern) in the error register 43m.

The error monitor control processing unit 45 of the error monitor unit 40 fetches the address signal HADDR [31:0] on the bus 10 and stores the same in the address storage region (Error Address) in the error register 43m.

The operation of the data communication bus system 1 when a transfer error occurs will be explained. As an example of the operation, consider a case where a DMAC constituting the bus master 202 writes 32 bits of data in a memory constituting the bus slave 301. The bus master 202 first transmits the transfer request signal HBUSREQ to the arbiter 50 via the control line 70. The arbiter 50 grants the transfer request thereof based on the arbitration and transmits the transfer grant signal HGRANT to the bus master 202 via the control line 70. Simultaneously, the arbiter 50 changes the master designation signal HMASTER [3:0] indicating the access right of the data communication to the code identifying the bus master 202, for example, “0010”.

When receiving the above transfer grant, the bus master 202 first transmits the 32-bit address signal HADDR [31:0] indicating the address of the destination of the data transfer on the bus slave 301 to the bus 10 in the address phase and, at the same time, transmits the above three types of control signals, that is, the transfer direction signal HWRITE, the transfer size signal HSIZE [2:0], and the burst transfer signal HBURST [2:0] to the bus 10.

In this example of operation, because of the writing of the data from the bus master 202 to the bus slave 301, the transfer direction signal HWRITE is “1”. Further, the transfer size signal HSIZE [2:0] is “010” (32 bits), and the burst transfer signal HBURST [2:0] is “100” (8-bit wrap type burst transfer).

On the other hand, the address data 60 generates the selection signal HSEL1 designating the bus slave 301 based on the address signal HADDR [31:0] and transmits the same to the bus 10.

By the above operation of the address phase, the bus slave 301 acquires the address signal HADDR [31:0], the above three types of control signals, and the selection signal HSEL1 from the bus 10.

Next, the routine shifts to the data phase, where the bus master 202 starts the transfer of the data for writing. The memory constituting the bus slave 301 in the present example acquires the data for writing from the bus 10 and starts the writing of the data received at the address designated by the address signal HADDR [31:0]. Here, for example, when the address designated by the address signal HADDR [31:0] does not exist in the memory constituting bus slave 301, the data cannot be written in the memory constituting the bus slave 301, therefore the bus slave 301 transmits “01” to the bus 10 as the transfer response signal HRESP [1:0] in order to notify the transfer error to the bus master 202.

In the data communication bus system 1 according to the present embodiment, the error monitor control processing unit 45 of the error monitor unit 40 constantly monitors this transfer response signal HRESP [1:0] and acquires the information required for analyzing (debugging) transfer error from the bus 10. First, the first comparator 41 compares the transfer response signal HRESP [1:0] and “01”. When deciding that they coincide, it changes the error signal S41 from the low level to high level. By this, the NMI terminal of the CPU per se or the first bus master 201 having the CPU becomes active, and the NMI processing is commenced in the first bus master 201.

The first decoder 42 of the error monitor unit 40 fetches the error signal S41 and the master designation signal HMASTER [3:0] on the bus 10 and performs the following decoding. At this time, the master designation signal HMASTER [3:0] changes to the code “0010” identifying the bus master 202, and the error signal S41 is at high level, therefore the first decoder 42 gives the latch signal S422 having the logic “1” to the error register 432 corresponding to the bus master 202.

Triggered by this latch signal S422, the error monitor control processing unit 45 of the error monitor unit 40 fetches the address signal and the control signal from the bus 10 into the error register 432.

Namely, the error monitor control processing unit 45 of the error monitor unit 40 fetches the transfer direction signal HWRITE (=“1”) on the bus 10 and stores it in the read/write designation (R/W) storage region in the error register 432. After the selection signal HSEL2 on the bus 10 is decoded by the second decoder 44, the error monitor control processing unit 45 of the error monitor unit 40 stores the bus slave number identified by the decoding in the slave no. storage region (Slave No.) in the error register 432. The error monitor control processing unit 45 of the error monitor unit 40 fetches the transfer size signal HSIZE [2:0] (=“010”) and the burst transfer signal HBURST [2:0] (=“100”) on the bus 10 and stores the same in the access pattern storage region (Access Pattern) in the error register 432. The error monitor control processing unit 45 of the error monitor unit 40 fetches the address signal HADDR [31:0] on the bus 10 and stores the same in the address storage region (Error Address) in the error register 432.

Based on the error signal S41 given from the first comparator 41 of the error monitor unit 40, the first bus master 201 performs the NMI processing and checks the error register group 43 in cooperation with the error monitor control processing unit 45 in that processing. In this way, the error monitor control processing unit 45 can acquire information for analyzing the transfer error relating to transfer of the bus master 202 from the first bus master 201.

Above, the case where error occurred in the transfer of a single bus master was explained, but the same is true for the case where transfer errors occur concerning a plurality of bus masters and the case where transfer error by one bus master induces transfer errors of other bus masters. Namely, the decoder 42 in the error monitor unit 40 distributes the latch signals for latching the error registers based on the master designation signal HMASTER [3:0] one after another, therefore the error register which becomes latched switches whenever the master designation signal HMASTER [3:0] is updated by the arbiter 50. By that, data such as addresses are sequentially stored in the corresponding error registers.

As explained above, according to the data communication bus system 1 of the present embodiment, when detecting transfer error, the error monitor unit 40 fetches the information concerning the transfer from the bus 10 for each bus master causing the transfer error, stores it in the corresponding error register of the error register group 43 having the storage region for each bus master, and notifies the same by NMI to the first bus master 201 having the CPU, so the following effects are obtained.

1. The data communication bus system 1 as a whole, irrespective of the type of the bus master, can store the information required for analyzing transfer error. For example, a case where sufficient error information is stored in a certain bus master (for example CPU), while useful error information is not stored in another bus master (for example DMAC) will not occur.

2. In the data communication bus system 1 according to the present embodiment, the processing can be unilaterally carried out by the error monitor unit 40 without depending upon the type of the bus master, and a multiple master bus system can be monitored with a relatively simple configuration.

3. In the data communication bus system 1 according to the present embodiment, even when composite (combined and complex) transfer errors occur, for example when transfer error by a certain bus master induces transfer errors of other bus masters, the error monitor unit 40 stores the error information for each bus master. Accordingly, for example, by accessing the error register in an interruption routine by the NMI in the first bus master 201, the transfer error can be easily debugged even in a complex multiple master bus system.

It should be understood by those skilled in the art that various modifications, combinations, sub-combinations and alterations may occur depending on design requirements and other factors insofar as they are within the scope of the appended claims or the equivalents thereof.

For example, in the above embodiment, as the specification of the bus 10, the explanation was given taking as an example the bus according to the AMBA specification of ARM Corporation, but the present invention is not limited to this. The specification of the bus 10 is not in limited in so far as the bus can handle multiple masters. It is clear that the present invention can be applied so far as transfer error can be detected from a signal on the bus, the bus master using the bus, the bus slave involved in the transfer, and the address designated by the transfer and other transfer information can be acquired.

In the above embodiment, the information concerning the read/write operation, the information identifying the slave, the information concerning the access pattern, and the address information were stored in the error register in the error monitor unit 40 for each bus master, but the present invention is not limited to this. So far as the information can be acquired from the bus and is useful for the debugging of the transfer error, the error register can be expanded so as to suitably store other information.

In the above embodiment, the address decoder decoded the address signal HADDR [31:0] transmitted from the bus master and transmitted the selection signal HSELn for selecting the bus slave involved in the data transfer to the bus 10, but a signal by which each bus master designates the bus slave may be directly transmitted to the bus 10 as well. In any case, the information for identifying the bus slave is transmitted from the bus master.

What we claim is:

1. A data communication system comprising:
a bus to which a plurality of bus masters and a plurality of bus slaves are connected and which transfers a data between a bus master and a bus slave;
a data storage unit having a plurality of data storage regions corresponding to the plurality of bus masters;
a detection unit for detecting a transfer error; and
a control unit for identifying a bus master, a bus slave and a transfer-related data from the data on the bus in accordance with the detection of the transfer error by the detection unit, the bus master and the bus slave which are related to the transfer error, and the transfer-related data which includes at least an address on the bus slave, and storing the data identifying the bus slave and the transfer-related data, in a data storage region corresponding to the identified bus master.

2. A data communication system as set forth in claim 1, wherein when the detection unit detects the transfer error, one bus master among the plurality of bus masters accesses the data storage unit.

3. A data communication system as set forth in claim 1, further comprising an arbitration unit for arbitrating data transfer requests of the plurality of bus masters, giving a data transfer grant to one bus master, and transmitting a first data identifying the one bus master to the bus, wherein:
the bus master given the data transfer grant transmits a second data identifying the bus slave and a third data identifying the address on the bus slave to the bus; and
the bus slave identified by the bus master transmits a fourth data indicating whether or not the data is properly transferred to the bus.

4. A data communication system as set forth in claim 3, wherein:
the detection unit detects the transfer error based on the fourth data, and
the control unit identifies the bus master based on the first data, in accordance with the transfer error detected by the detection unit, and stores the second and third data in the data storage region corresponding to the bus master.

5. A data communication system as set forth in claim 4, wherein the control unit includes:
a decoding unit for decoding the fourth data to identify the bus master;
a latching unit for latching a data storage region corresponding to the bus master identified by said decoding unit from said plurality of data storage regions; and
a data acquiring means for acquiring the second and third data from the bus, and storing the acquired second and third data in the data storage region latched by the latching unit.

6. A data communication system as set forth in claim 4, wherein:
the bus master sends to the bus at least one data among of a fifth data indicating a read/write operation of data transfer, a sixth data indicating an amount of data relating to said data transfer, and a seventh data indicating the type of said data transfer; and
the control unit stores the one data in the corresponding data storage region.

7. A data communication system as set forth in claim 3, wherein when the detection unit detects the transfer error based on the fourth data, one bus master among the plurality of bus masters accesses the data storage unit.

8. A data communication method for transferring a data on a bus to which a plurality of bus masters and a plurality of bus slaves are connected, including:
a step of detecting a transfer error;
a step of identifying a bus master, a bus slave and a transfer-related data from the data on the bus, the bus master and the bus slave which are related to the transfer error, the transfer-related data which includes at least an address on the bus slave;
a step of storing the data of the bus slave and the transfer-related data in a data storage region corresponding to the identified bus master; and
a step of accessing the data storage region by one bus master among the plurality of bus masters.
